(19) United States
(12) Patent Application Publication
(10) Pub. No.: US 2020/0346117 A1
(43) Pub. Date: Nov. 5, 2020

(54) TRIGGER FOR GAME EVENTS

(71) Applicant: MOGEES LTD, London (GB)

(72) Inventors: Conor BARRY, London (GB); Bruno ZAMBORLIN, London (GB); Parag MITAL, Valencia, CA (US); Baptiste CARAMIAUX, Paris (FR); Alessandro SACCOIA, Brescia (IT)

(21) Appl. No.: 16/760,645

(22) PCT Filed: Oct. 31, 2018
(86) PCT No.: PCT/GB2018/053147

§ 371 Date: Apr. 30, 2020

(30) Foreign Application Priority Data
Oct. 31, 2017 (GB) 1718007.6

(51) Int. Cl. A63F 13/65; A63F 13/211

(52) U.S. Cl. CPC A63F 13/65; A63F 13/211

(57) ABSTRACT

The present invention relates to a method for triggering a game event. The method includes the steps of detecting vibration signals from one of a plurality of physical game actions actuated by a user on a surface using a vibration sensor; processing the vibration signal to determine which of the plurality of physical game actions was actuated; and triggering a game event based upon the determined game action.

### FIELD OF INVENTION

The present invention is in the field of game apparatus. More particularly, but not exclusively, the present invention relates to game apparatus for triggering game events.

### BACKGROUND

Traditionally game consoles, electronic games, and party games require dedicated control devices for the users to interact with the game. Commonly these controllers combine buttons, joysticks and sometimes motion sensors. Interaction with these game controllers by users trigger game events within a gaming system.

However, these game controllers can often be expensive to manufacture and limit the range of gameplay possibilities to the user or gaming system.

Board games, role playing games, and table-top games may also have items that users manipulate or move in order to perform actions in a game, but these items lack any ability to communicate with or control other devices such as score keeping, displays, or other game components.

It would be desirable if manipulation of these items could also trigger game events.

It is an object of the present invention to provide a method and system for triggering game events which overcomes the disadvantages of the prior art, or at least provides a useful alternative.

### SUMMARY OF INVENTION

According to a first aspect of the invention there is provided a method for triggering a game event, including:

a) detecting vibration signals from one of a plurality of physical game actions actuated by a user on a surface using a vibration sensor;

b) processing the vibration signal to determine which of the plurality of physical game actions was actuated; and

c) triggering a game event based upon the determined game action.

Other aspects of the invention are described within the claims.

### BRIEF DESCRIPTION OF THE DRAWINGS

Embodiments of the invention will now be described, by way of example only, with reference to the accompanying drawings in which:

FIG. 1a: shows a flow diagram illustrating a method in accordance with an embodiment of the invention;

FIG. 1b: shows a block diagram illustrating a system in accordance with an embodiment of the invention; and

FIGS. 2 to 13: show diagrams illustrating different embodiments of the invention.

### DETAILED DESCRIPTION OF PREFERRED EMBODIMENTS

The present invention provides a method and system for triggering game events.

The inventors have discovered that a vibration sensor in contact with a surface can be used to detect vibration signals from different physical game actions caused by a user. Processing these vibration signals enables the different game actions to be distinguished and to trigger specific game events.

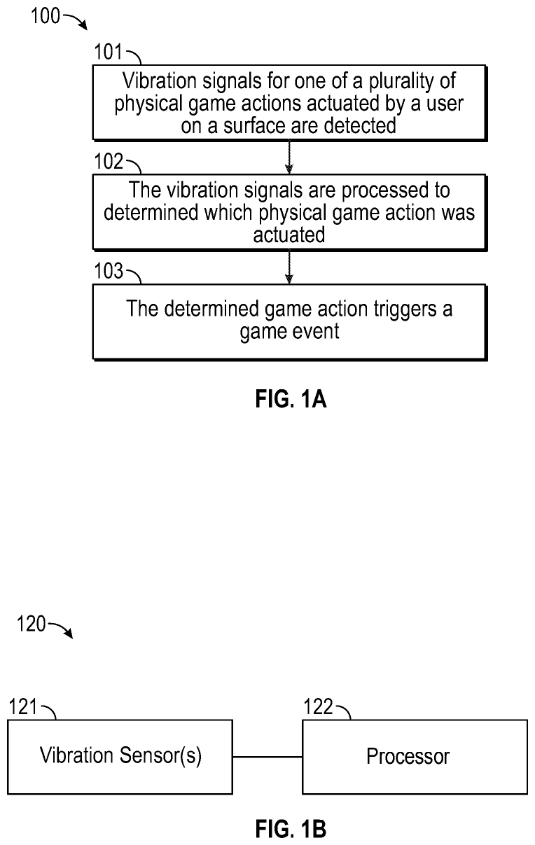

Referring to FIG. 1a, a method 100 for triggering game events in accordance with an embodiment of the invention will be described.

In step 101, vibration signals are detected on a surface using a vibration sensor. The signals may be detected from one of a plurality of physical game actions actuated by a user on the surface.

The vibration sensor may be placed on, within, or under a first object/element which forms the surface or on another object/element from which vibrations from the first object/element are transmissible.

The vibration sensor may be a vibration transducer which uses one method selected from the set of capacitive, piezoelectric, electrostatic, fibre-optic, electromagnetic, visual, carbon, laser, and MEMS.

The vibration signals may be detected at one or more of a plurality of vibration sensors.

The physical game action may include one or more distinguishing feature such as type (e.g. tap or swipe), location (e.g. at a 2D coordinate or area on the surface), intensity (e.g. hard tap or soft tap), duration (e.g. fast swipe or slow swipe) and/or pattern (e.g. double tap).

The physical game action may be actuated directly upon the surface by the user.

The type of physical game action may be a physical user action or gesture such as:
Index finger tap
Middle finger tap
Side of thumb tap
Flat of index finger tap
Flat of middle finger tap
Minor knuckle tap
Major knuckle tap
Hand slap
Finger scratch
Nail scratch
Finger slide
Circular finger slide
Index finger flick
Sitting down
Footsteps
Kicks
Elbow hits
Head-butts
Punches
Flat hand swipes
Side of hand chops
Side of finger chops (with 1, 2, 3, 4 fingers)

The physical game action could be effected by the user's feet, hands, elbow, head, knee, or any other part of the user's anatomy.

The physical game action may be actuated indirectly upon the surface by the user. For example, via an exciter such as a tool (e.g. a drumstick), game object or item (e.g. a gameplay piece), or projectile (e.g. thrown or fired by the user).

The physical game action may be actuated indirectly upon the surface via one of a plurality of objects or elements connected to the surface, such that vibrations are transmissible from the objects or elements to the surface. For example, the objects may be a plurality of targets and the location feature of a physical game action may indicate which of the targets is struck.

The physical game action may be actuated by one of a plurality of users.

In step 102, the vibration signals are processed to determine which of the physical game actions was actuated.

The vibration signals may be processed by a processor. The processor may be co-located with the vibration sensor, at a gaming device, or at another device. The vibration sensor, processor, and gaming device may be connected via one or more of wireless (e.g. wifi, Zigbee or Bluetooth) or wired (serial, USB or Ethernet) communications. The processor may be located remotely, such as within a network or cloud apparatus or system.

In embodiments, the vibration sensor and processor are located at the gaming device.

In embodiments, the vibration sensor is located within the exciter.

The determination may further indicate which of a plurality of users actuated the physical game action.

In step 103, a game event is triggered based upon the determined game action.

The game event may be triggered at the gaming device. The game event may be sent from the processor to the gaming device.

The game event may be a discrete game event such as a point awarded, target hit, or gameplay piece moved or a continuous game event such as distance travelled or balance kept.

The game event may reflect virtual actions within game executing on a computing device such as a tablet, smartwatch, smartphone, game console, computer, or VR/AR headset, or within an electronic gaming device or electronic game board.

In FIG. 1b, a system 120 in accordance with an embodiment of the invention is shown.

The system 120 may include one or more vibration sensors 121. The vibration sensors 121 may be in direct or indirect physical contact with a surface. The vibration sensors 121 may be configured to detect vibrations generated by physical game actions actuated by a user on the surface. The physical game actions may be via direct user gestures such as tapping with the user's hand, for example, or via indirect user physical action such as striking the surface with an object.

The system 120 may also include a processor 122 configured to receive signals from the vibration sensor(s) 121, process the signals to distinguish which of a plurality of different physical game actions was actuated, and trigger a game event 123 based upon the determined game action.

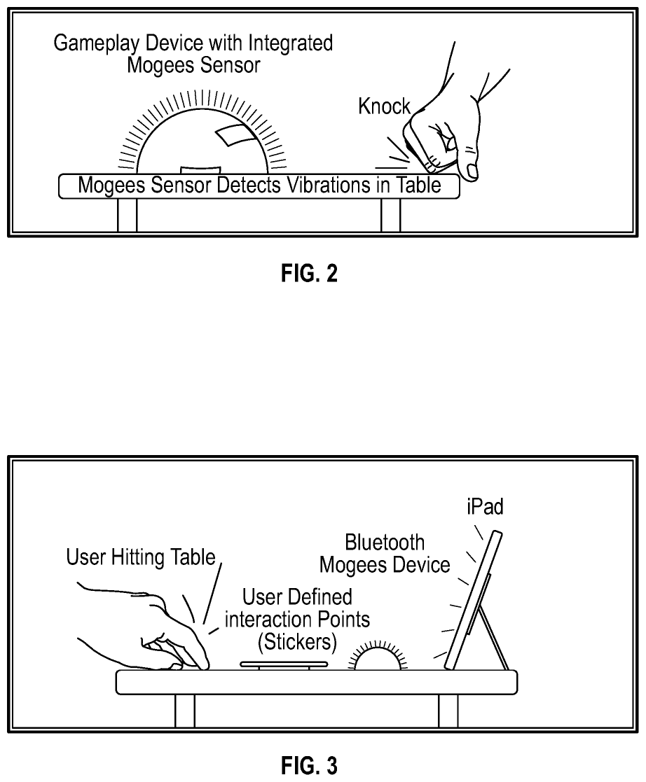

FIGS. 2 to 13 illustrate different embodiments of the present invention which may utilise the method described in relation to FIG. 1.

FIG. 2 illustrates an embodiment for tabletop gaming using an embedded standalone device.

Here, a gaming device (perhaps with lights, a speaker, or display), prompts gameplay actions (such as ‘Simon Says™ Hit Blue’) to a user.

The user then plays the game by performing actions that induce vibrations within the object to which the gaming device is attached.

The gaming device itself contains a vibrations sensor and processor (referred to herein as a Mogees™ device) that can interpret these vibrations into game events.

FIG. 3 illustrates an embodiment for tabletop gaming using Mogees device communicating to gameplay device

In this example, the Mogees device is attached to the table.

When the user strikes the table, vibrations are induced and picked up by the Mogees device.

The Mogees device interprets these vibrations and translates them into game events.

These game events are communicated via bluetooth to a receiving device (e.g. iPad or iPhone).

It is the iPad or iPhone that performs all of the gameplay prompts, cues, visualisations, feedback etc.

The user can define interaction points using stickers or items placed upon the table, and train the Mogees device to recognise these action points

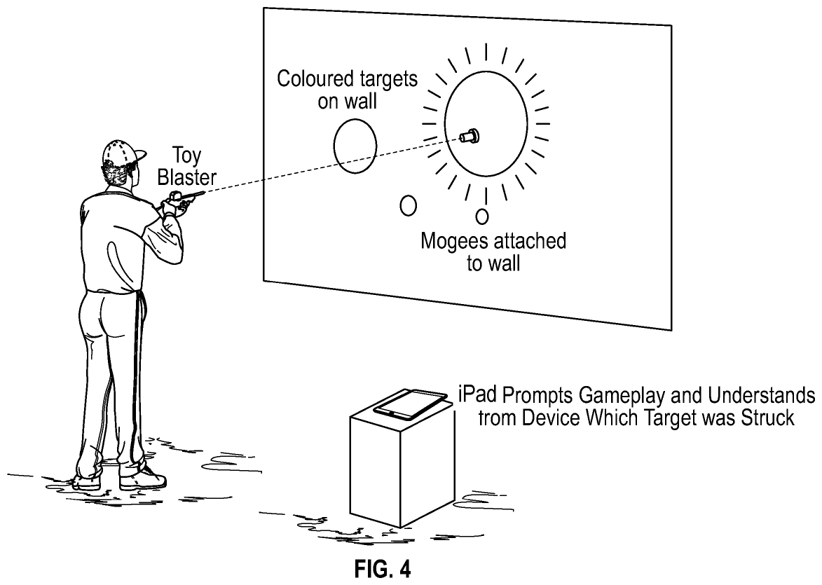

FIG. 4 illustrates an embodiment for a dart gun.

The user(s) has a toy dart gun.

They fire darts at a wall.

This wall has one or more targets attached to it.

A Mogees attached to this same wall can detect which target was struck or whether it hit the wall.

This event is communicated wired or wirelessly to a receiving device.

This receiving device can be a smartphone/tablet, or separate electronic component that can display to the user the result.

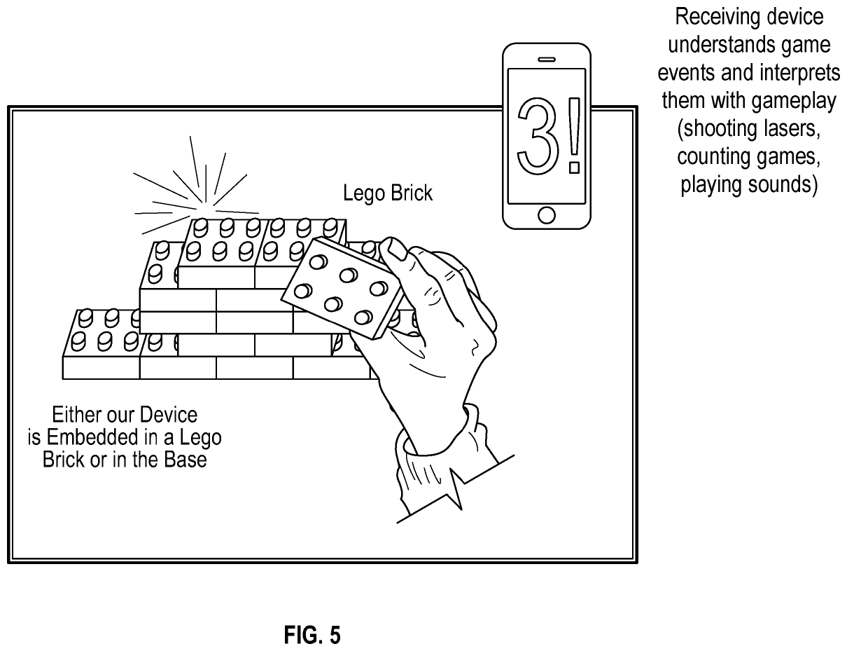

FIG. 5 illustrates an embodiment for toy bricks.

A Mogees device is embedded within a toy brick, or in the base plate for toy bricks.

The user places, removes, or interacts with bricks.

The mogees sensor can detect whether the user has added a brick, removed a brick, or hit/touched one or more bricks.

This information is communicated as a game event to a receiving device.

This could be something like counting games or challenges for the number of bricks.

Or building structures to fight aliens on screen etc

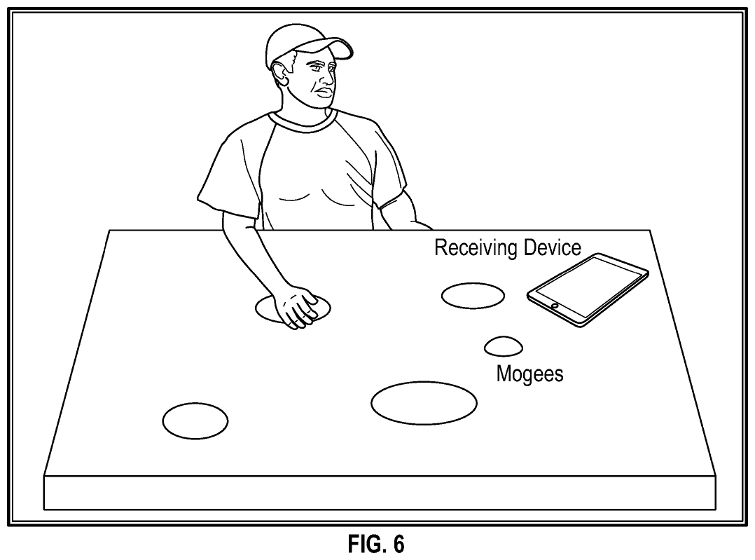

FIG. 6 illustrates an embodiment for Single Player Table Top Game.

A Mogees device is attached to the table.

The user has marked different positions on the table using stickers or attachments, each with a colour.

A receiving device initiates gameplay—for example follow the pattern in ‘Simon™’, reaction whack-a-mole, rhythm action games—hit the right one in time.

The Mogees device detects the vibrations as the user taps the different attachments in different ways, and corresponds them to gameplay actions on the receiving device.

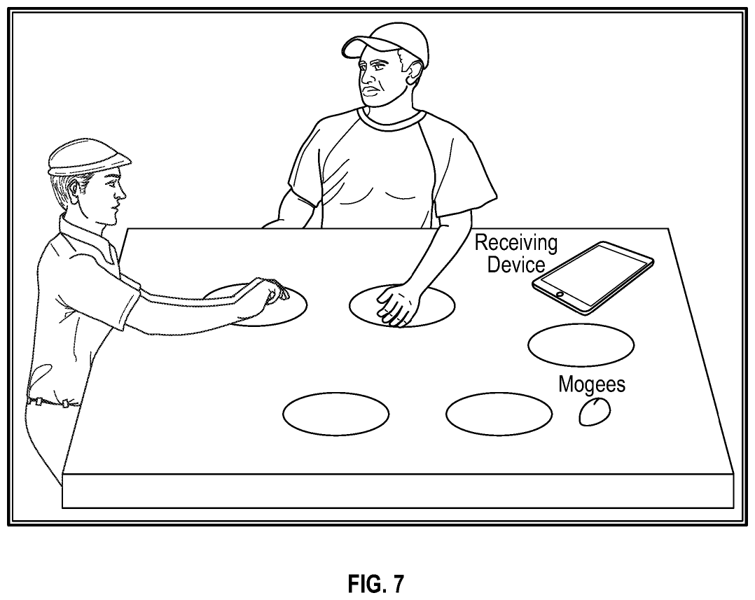

FIG. 7 illustrates an embodiment for Multiplayer Table Top Gaming.

Two or more users interact with a playing surface to play games.

Stickers or attachments are placed in contact with the table.

A receiving device initiates gameplay.

As the users strike the attachments, these are communicated as gameplay events to the receiving device.

Scenarios:

Quiz Buzzer—each player has their own hit zone/gesture/attachment to strike. First one to hit, gets to answer the question

Reaction time—hit your one faster that then others

Pattern games—perform a combination of taps or strikes and the other users must follow

(NOTE—this could work without the stickers/attachments)

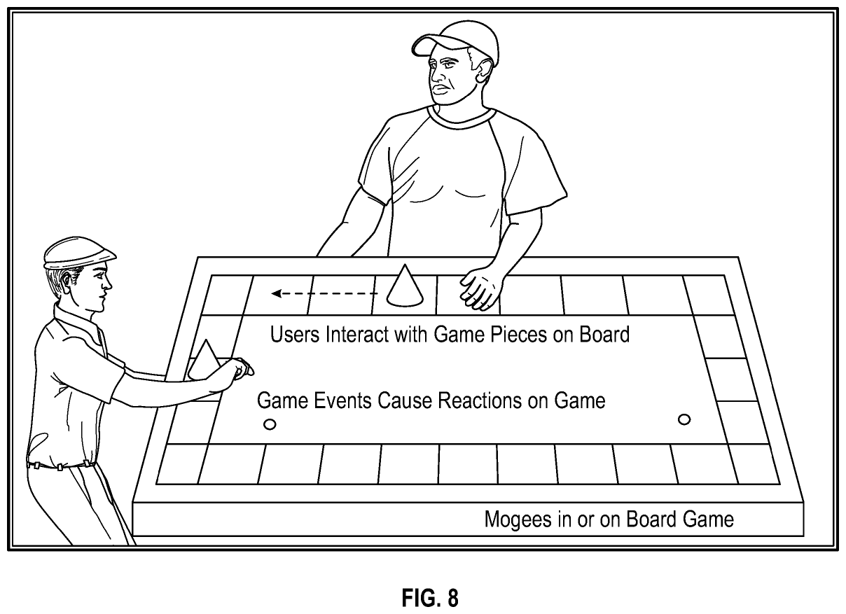

FIG. 8 illustrates an embodiment for a board game.

A Mogees device is in contact with a playing surface.

Users interact with gameplay pieces on that board, and can perform actions that result in various gameplay outcomes.

E.g. tap the top of your figurine/scratch your character across/knock your character over in order to score points, progress, change game state.

Receiving device can be smartphone/tablet or integrated processor/module built into or accompanying the playing surface.

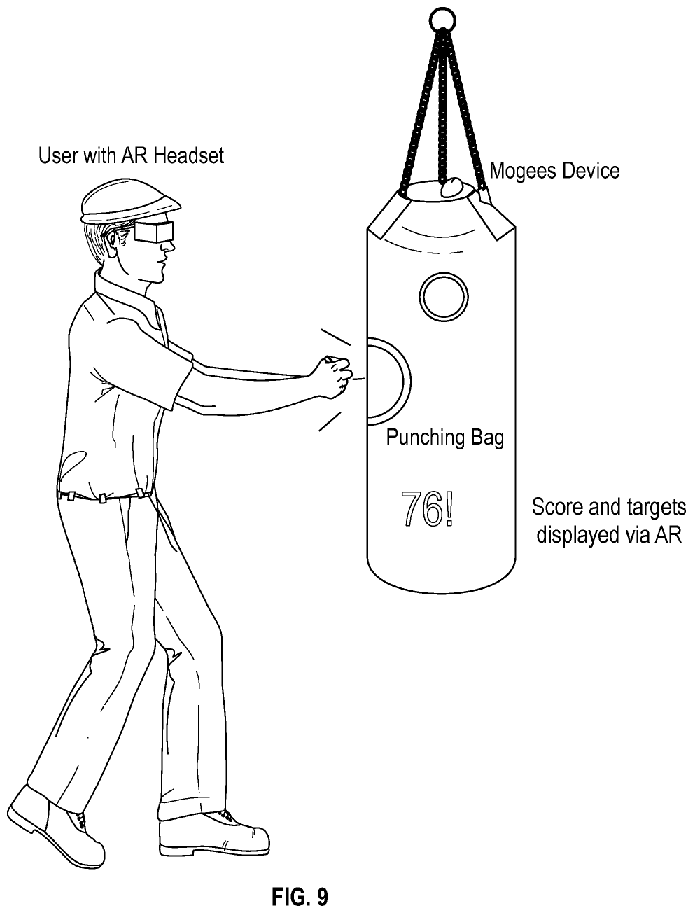

FIG. 9 illustrates an embodiment for Augmented Reality/Punching Bag.

Mogees sensor(s) is/are embedded within punch bag.

Augmented reality headset on user, overlays gameplay visuals on the punch bag.

Targets and prompts appear on the punch bag.

User performs the prompted actions and the actions create vibrations within punch bag.

These vibrations are analysed and translated into game events which are communicated back to the user via the AR headset.

Processing can happen on the headset, an external processing unit, or in a processing unit within the punchbag. These can be wired or wireless.

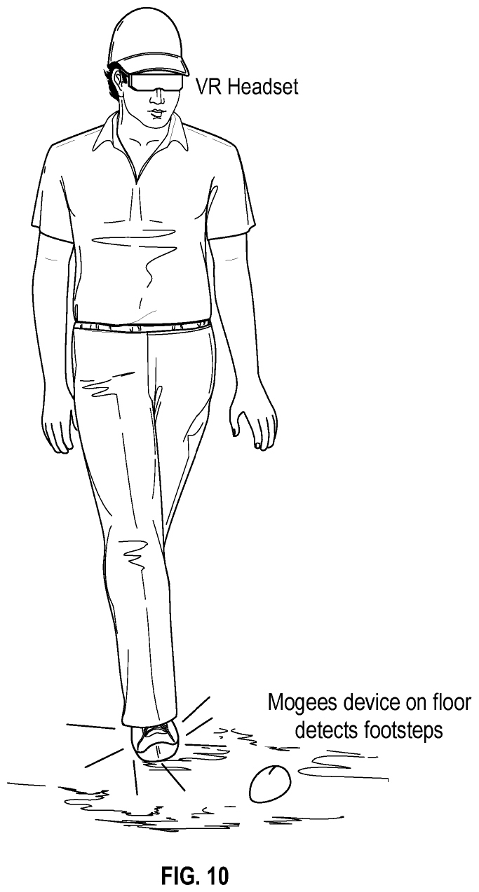

FIG. 10 illustrates an embodiment for VR Footstep Tracking.

A Mogees device is attached to or embedded within the floor.

The user is wearing a VR headset.

The Mogees device detects footsteps, and can tell the difference between running, walking, stomping, tip toeing.

Multiple Mogees sensors could detect user walking direction.

This information is relayed to gaming device and/or VR headset to control the motion or actions of the in-game character.

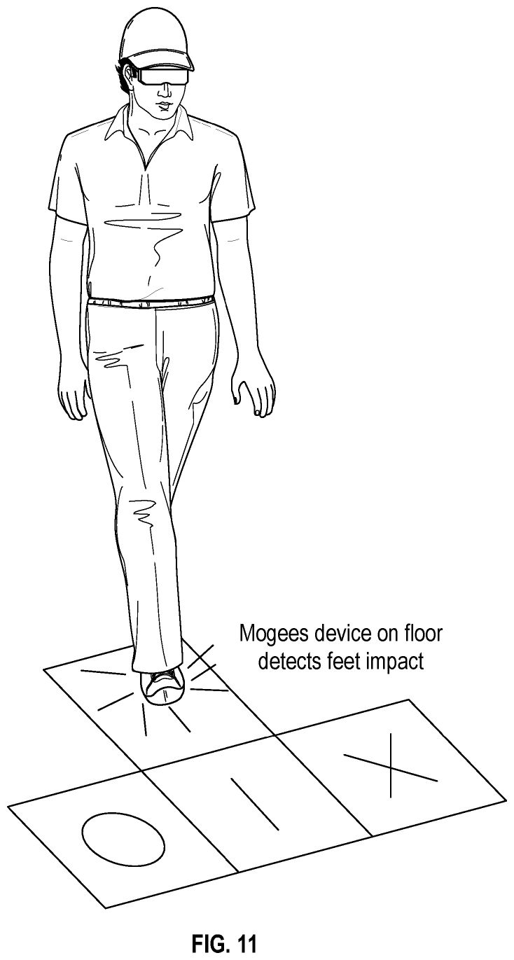

FIG. 11 illustrates an embodiment for Dance floor/Hopscotch.

The user places the Mogees device on a floor.

The user can configure action points on the floor by teaching the device each action they wish to convert to a game event.

In gameplay scenarios that occur on the device or on a separate game device, they can then use these actions to control game events.

E.g. setup a dance pad with 4 points. The game prompts them to tap their feet in the right point at the right time and scores them.

Different game idea; Hopscotch—user defines each of the points and corresponds them to a tile on hopscotch. A receiving device prompts/scores/gives feedback or visualises their actions.

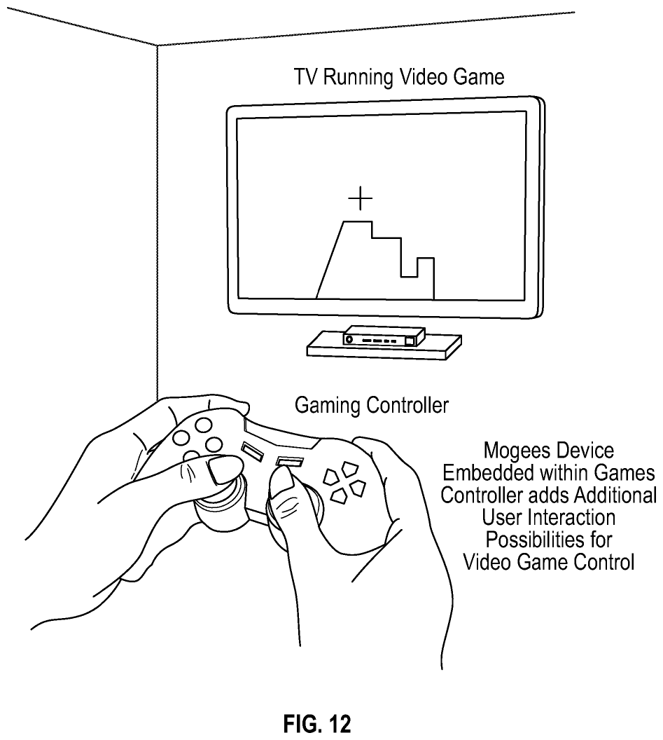

FIG. 12 illustrates an embodiment for a Video Game controller.

A handheld video game controller contains a Mogees device.

The device augments the existing controls by adding information such as force, interaction type (finger/thumb/knuckle scratch) and uses these to customise and augment the control commands sent to the video game console.

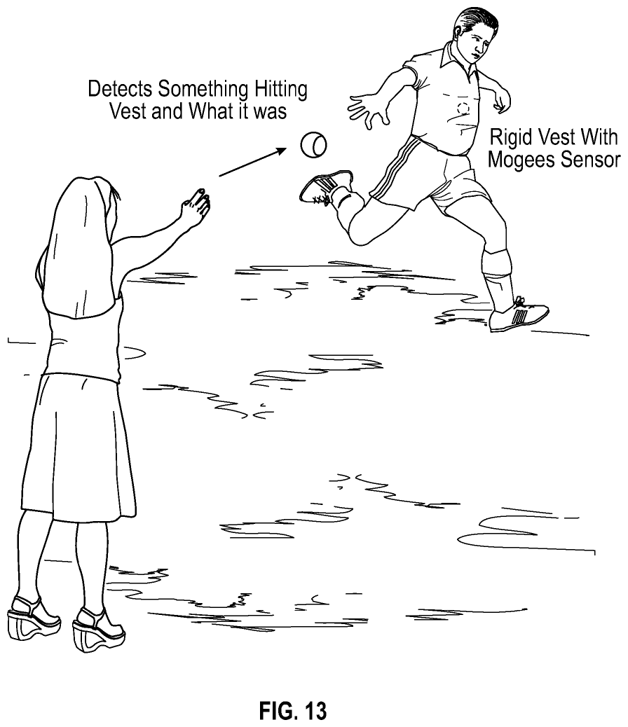

FIG. 13 illustrates an embodiment for a Wearable Tag Vest.

Users wear vests that have rigid surfaces and contain embedded Mogees sensors.

The Mogees can detect different actions such as being struck by hands, balls, darts, or other projectiles.

The Mogees can also distinguish the intensity and position of the strike.

These actions can be communicated to the user via a gameplay indicator such as a sound, light, or display.

Potential advantages of some embodiments of the present invention are that:
1. This device allows users to interact directly with the playing surface, using any part of their body or exciters. This allows for new forms of interaction and gameplay, using a device that is affordable to manufacture and set up.
2. By attaching this device to a surface or objects within the game, users can perform actions that directly control and contribute to gameplay.

Further potential advantages of some embodiments of the present invention include:
Open-ended interface for gaming;
Novelty;
Potential for user defined controls, rather than pre-determined controls;
Cheap hardware and scalable;
More expressive gameplay—hits, strikes, taps etc;
Accessible for all users—few motor skills restrictions; and
Interaction with real world objects instead of on limited touchscreens.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1-29. (canceled)

30. A method for triggering a game event, including:
a) detecting vibration signals from one of a plurality of physical game actions actuated by a user on a surface using a vibration sensor;
b) processing the vibration signal to determine which of the plurality of physical game actions was actuated; and
c) triggering a game event based upon the determined game action.

31. A method as claimed in claim 30, wherein the processing is performed by a processor co-located with the vibration sensor.

32. A method as claimed in claim 30, wherein the game event is triggered at a gaming device.

33. A method as claimed in claim 32, wherein the vibration signals or the game event are/is transmitted to the gaming device.

34. A method as claimed in claim 32, wherein the processor and vibration sensor are within the gaming device.

35. A method as claimed in claim 30, wherein each physical game action is actuated directly by the user on the surface.

36. A method as claimed in claim 35, wherein each physical game action is actuated by a gesture performed by the user upon the surface.

37. A method as claimed in claim 35, wherein each physical game action is actuated by the user's hands, feet, or elbow on the surface.

38. A method as claimed in claim 30, wherein each physical game action is actuated indirectly by the user on the surface.

39. A method as claimed in claim 38, wherein each physical game action is actuated by an exciter on the surface and wherein the exciter is a gameplay piece.

40. A method as claimed in claim 39, wherein the vibration sensor is within the exciter.

41. A method as claimed in claim 30, wherein the one of the plurality of physical game actions is actuated by one of a plurality of users and wherein the vibration signal is processed to determine which of the plurality of users actuated the one of the plurality of game actions.

42. A method as claimed in claim 30, wherein the surface is the surface of an object and the vibration sensor is placed on, underneath, or within the object.

43. A method as claimed in claim 32, wherein the gaming device is a tablet, smartphone, smartwatch, VR or AR headset, gaming console, computer, electronic gaming device or electronic board game.

44. A method as claimed in claim 30, wherein the vibration sensor is within a handheld game controller.

45. A method as claimed in claim 30, wherein the vibration sensor is a vibration transducer which uses one method selected from the set of capacitive, piezoelectric, electrostatic, fibre-optic, electromagnetic, visual, carbon, laser, and MEMS.

46. A method as claimed in claim 30, wherein the vibration signals are detected from the physical game action on the surface at one or more of a plurality of vibration sensors.

47. A method as claimed in claim 30, wherein processing of the vibration signal includes determining features of the physical game action.

48. A method as claimed in claim 47, wherein the features include one or more selected from the set of type, location, intensity, duration, and pattern.

49. A method as claimed in claim 30, wherein the surface is a surface of a first element and the vibration sensor is embedded on, behind, or inside the first element.

50. A method as claimed in claim 30, wherein the surface is a surface of a first element and the vibration sensor is embedded on, behind, or inside a second element connected to the first element such that vibrations are transmissible from the first element to the second element.

51. A system for triggering game events, including:
One or more vibration sensors configured to associate with a surface and to detect one of a plurality of physical game actions actuated by a user on the surface; and
A processor configured to process the vibration signals to determine which of the plurality of physical game actions is actuated and to trigger game events based upon the determined game actions.
